(19) United States
(12) Patent Application Publication
(10) Pub. No.: US 2020/0102931 A1
(43) Pub. Date: Apr. 2, 2020

(54) Wind Turbine

(71) Applicant: Edward John Koch, Calgary (CA)

(72) Inventor: Edward John Koch, Calgary (CA)

(21) Appl. No.: 16/149,374

(22) Filed: Oct. 2, 2018

(51) Int. Cl. F03D 1/06; F03D 9/25; F03D 7/02

(52) U.S. Cl. CPC F03D 1/0641; F03D 7/0272; F03D 7/0224; F03D 9/25

(57) ABSTRACT

A wind turbine comprises a rotor comprising radially outwardly extending blades which are twisted in cross-sectional shape so as to achieve a constant angle of attack. Additionally, the blades are connected at their outer ends to a peripheral rotor ring which is arranged to engage and drive a rotary member of a generation system of the wind turbine that is mounted at a fixed angular position relative to the rotor ring. The wind turbine is operated in a manner which includes determining for each of a plurality of wind speeds a relationship between rotation rate and optimum power output and varying the power output of the generation system to change the load on the rotor to maintain the rotation rate at or adjacent the rotation rate which provides the optimum power output.

This invention relates to a wind turbine, and particularly to a wind turbine suited for power generation in high wind speed.

### BACKGROUND OF THE INVENTION

There exist a number of shortcomings with conventional wind turbines that do not enable them to be used during high wind speed conditions, to the extent that in some circumstances the wind turbines are shut off entirely when the wind speed exceeds a prescribed threshold thereby limiting the amount of electrical power that can be harvested from the wind. Additionally, conventional wind turbines exhibit several inefficiencies in high wind speeds. Particularly, wind turbines have a tendency to over speed in such conditions until the blades stall, such that the mechanical output power of the blades matches the load of the generator thereon, and thus no net electrical power is generated, or output, by the generator.

### SUMMARY OF THE INVENTION

According to an aspect of the invention there is provided a method of operating a wind turbine comprising:

a rotor;

a rotor mount for supporting the rotor in a prevailing wind such that the flowing of the wind at a wind speed causes rotation of the rotor at a rotation rate which varies in response to wind speed;

a generation system responsive to the rotation of the rotor to generate an electrical power output which applies a load to the rotor;

the method comprising:

determining for each of a plurality of wind speeds a relationship between rotation rate and optimum power output and varying the power output of the generation system to change the load on the rotor to maintain the rotation rate at or adjacent the rotation rate which provides the optimum power output.

Further to the shortcoming that conventional wind turbines tend to over speed, the Applicant has observed that there is an optimum rotation rate for a particular (and typically fixed) angle of attack of a rotor blade for a given wind speed. As such, the foregoing arrangement not only prevents over speeding of the rotor but also enables the power output of the wind turbine to remain at an optimal level. Preferably this is achieved by operating the generation system as a “regenerative brake” to selectively exert additional mechanical load on the spinning rotor in order to brake and maintain the rotation rate at the optimum rotation rate or within a prescribed range thereabout.

Preferably the relationship is obtained for the different wind speeds as stored data and, during operation, the wind speed is measured so as to determine the optimum rotation rate and the generation system is varied to maintain the load at a required level to maintain the optimum rotation rate.

Preferably the load is maintained at a required level to maintain the optimum rotation rate by detecting whether, for the prevailing wind speed, the rotor is operating at optimum rotation rate and if not by varying the power output to change the load and thus the rotation rate.

The generation system may include a variable frequency drive to change the power output.

According to another aspect of the invention there is provided a wind turbine comprising:

a rotor;

a rotor mount for supporting the rotor in a prevailing wind such that the flowing of the wind at a wind speed causes rotation of the rotor at a rotation rate which varies in response to wind speed;

a generation system responsive to the rotation of the rotor to generate an electrical power output which applies a load to the rotor;

the rotor comprising:
a plurality of blades mounted at angularly spaced locations for rotation about an axis, each blade extending generally radially outwardly from the axis and including an inner blade end and an outer blade end;
each blade having at each location along its length a shape in cross-section which defines an airfoil;
the airfoil having at each said location a leading edge facing the prevailing wind, a trailing edge, a lift surface and an opposed surface where a distance along the lift surface from the leading edge to the trailing edge is greater than a distance along the opposed surface from the leading edge to the trailing edge;
the airfoil having at each said location a straight line joining the leading edge and the trailing edge lying at an obtuse angle to a radial plane;
wherein the obtuse angle increases from the inner end of the blade to the outer end;
and wherein at each said location the obtuse angle is proportional to a length of a radius from the axis to the line.

The Applicant has observed that different areas of the respective rotor blade which are at different distances from the axis of rotation travel at different tangential speeds for a given rotation rate of the rotor. In order to maximize efficiency of the wind turbine by maintaining a constant angle of attack of the rotor blade for a given current wind speed, which are interrelated by the tangential speed of the rotating blade, the blade is twisted in cross-sectional shape so that the rotational force exerted by the wind on the blade and therefore effecting rotation of the rotor is uniform along the blade length.

According to yet another aspect of the invention there is provided a wind turbine comprising:

a rotor;

a rotor mount for supporting the rotor in a prevailing wind such that the flowing of the wind at a wind speed causes rotation of the rotor about a rotor axis at a rotation rate which varies in response to wind speed;

a generation system responsive to the rotation of the rotor to generate an electrical power output which applies a load to the rotor;

the rotor comprising a plurality of blades mounted at angularly spaced locations for rotation about an axis, each blade extending generally radially outwardly from the axis and including an inner blade end and an outer blade end;

the rotor comprising a peripheral rotor ring connected to the blades at the outer ends of the blades;

the rotor mount including a stator ring at the rotor ring and defining rotational bearings allowing the rotation of the rotor ring and a thrust bearing holding the rotor against axial movement;

the generation system including a rotary member mounted on the stator ring at a fixed angular position thereon for rotation about an axis parallel to the rotor axis;

the rotor ring carrying an annular member for engaging and driving the rotary member at a rate greater than that of the rotor as the rotor ring rotates past the rotary member.

The Applicant has observed that, typically, rotors of wind turbines operate at low rotation rates, and therefore at high torque (since the product of the two is power). However, electrical generators are better suited for operating at low torque, which leads to an inherent mismatch in specifications between the rotor and generator of a wind turbine. The foregoing arrangement provides a simpler configuration for converting the unsuitably low rotation rate of the rotor into a higher rotation rate as an input to the generation system.

Preferably an average of the obtuse angles lies in the range 100 to 125 degrees, preferably in the range 106 to 117 degrees and most preferably in the order of 112 degrees.

Preferably the obtuse angle at the inner end lies in the range 92 to 100 degrees and preferably in the range 95 to 99 degrees.

Preferably the obtuse angle at the outer end lies in the range 110 to 140 degrees and preferably in the range 120 to 135 degrees.

Preferably the obtuse angle at the inner end is no less than 92 degrees and the obtuse angle at the outer end is no greater than 140 degrees.

Preferably the obtuse angle changes continuously and smoothly through the length of the blade from the inner end to the outer end.

Preferably the leading edges lie in a common radial plane and the trailing edges lie in a common radial plane.

Preferably the inner end is located at a hub to which the blades are attached.

Preferably the outer end is located at an outer ring to which the blades are attached.

Preferably the outer ring, i.e., the peripheral rotor ring, is cylindrical around the axis.

Preferably the rotational bearings comprise a plurality of angularly spaced roller bearings mounted between an outwardly facing surface of the rotor ring and an inwardly facing surface of the stator ring.

Preferably the stator ring includes a forwardly facing stator surface lying generally in a radial plane of the stator ring against which the rotor ring applies axial force from the prevailing wind.

In an arrangement, the annular member comprises a peripheral ring such as a belt or chain having outward projections for driving a sprocket on the rotary member.

The rotary member may rotate at a rate at least 25 times and preferably 100 times greater than that of the rotor.

### BRIEF DESCRIPTION OF THE DRAWINGS

The invention will now be described in conjunction with the accompanying drawings in which:

FIG. 1 is a schematic diagram of arrangement of wind turbine according to the present invention;

FIG. 2 is a side elevational view from an inner end of a blade of the wind turbine arrangement of FIG. 1;

FIG. 3 is an enlarged end elevational view schematically showing an upper portion of the wind turbine arrangement of FIG. 1; and

FIG. 4 is a schematic cross-sectional view of the upper portion of FIG. 3.

In the drawings like characters of reference indicate corresponding parts in the different figures.

### DETAILED DESCRIPTION

The accompanying figures illustrate a wind turbine 10 which is suited for operating in high wind speeds. The wind turbine 10 comprises a rotor 12 and a rotor mount 15 including at least a tower 16 for supporting the rotor 12 in a prevailing wind 17 such that the flowing of the wind 17 at a wind speed causes rotation of the rotor 12 at a rotation rate which varies in response to wind speed. The wind turbine 10 further includes a generation system 20 that is responsive to the rotation of the rotor 12 to generate an electrical power output which applies a load to the rotor 12. Typically the output of the generation system 20 is operatively connected to an electrical load 22 such as a home or an electrical power system grid (generally speaking, an electricity consumer(s)) to which the electrical power output is fed for subsequent consumption.

The rotor 12 comprises a plurality of blades 24 mounted at angularly spaced locations for rotation about an axis 25. Each blade 24 extends generally radially outwardly from the axis 25 and includes an inner blade end 27 and an outer blade end 28.

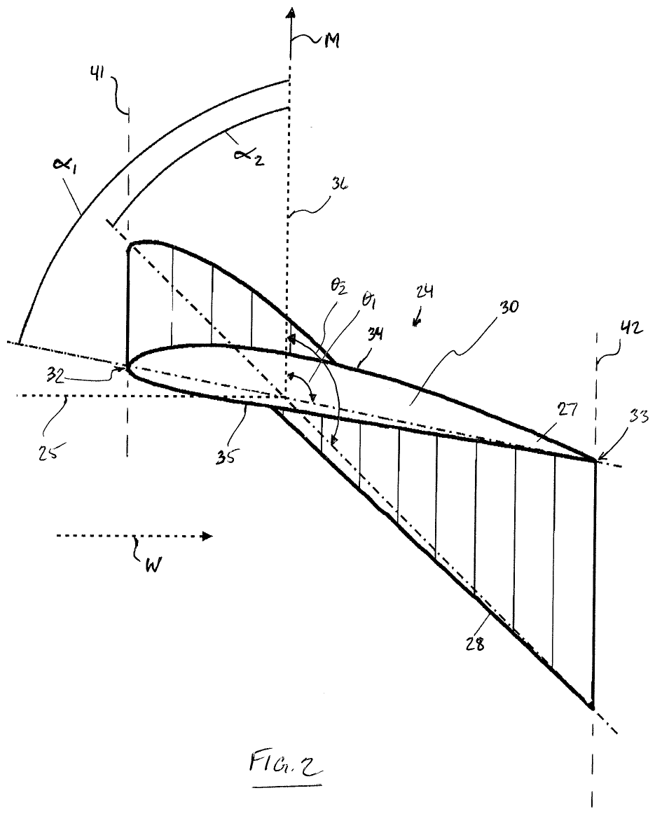

Each blade 24 has at each location along its length a shape in cross-section which defines an airfoil 30 as more clearly shown in FIG. 2. The airfoil 30 has at each said location a leading edge 32 facing the prevailing wind, a trailing edge 33, a lift surface 34 and an opposed surface 35 where a distance along the lift surface 34 from the leading edge 32 to the trailing edge 33 is greater than a distance along the opposed surface 35 from the leading edge 32 to the trailing edge 33, as would be conventionally understood by a person of skill in the art.

The airfoil 30 has at each location along the blade length an imaginary straight line joining the leading edge 32 and the trailing edge 33 lying at an obtuse angle to a radial plane 36. In FIG. 2 only two such straight lines, which in industry are also termed airfoil chords, are shown where one of these is the line 37 corresponding to the inner blade end 27 and the other indicated at 38 corresponds to the outer blade end 28, and further the obtuse angle at the inner end 27 is indicated at 81 and that at the outer end 28 is indicated at 82. These obtuse angles substantially correspond to the angle of attack of the blade 24 at different locations thereon which are at different distances from the axis 25. For wind turbines and the like, the angle of attack is typically an acute angle measured with respect to the direction of rotation of the blade 24, which, as shown in FIG. 2, is an upward direction lying along the radial plane 36. The corresponding angles of attack for obtuse angles θ1 and θ2 are indicated at α1 and α2 for the inner and outer blade ends 27, 28, respectively.

Still referring to FIG. 2, for optimally efficient operation of the wind turbine, which is achievable at least in part by maintaining a constant angle of attack of the rotor blade 24 for a given current wind speed, the obtuse angle increases from the inner end 27 of the blade to the outer end 28, that is from θ1 to θ2, but in a manner so that at each radial blade location the respective obtuse angle is proportional to a length of a radius from the axis 25 to the imaginary line, for example 37 or 38, corresponding to that location on the blade 24. In other words, the angle of attack decreases from the inner blade end 27 to the outer blade end 28, that is from α1 to α2. This is because each location along the length of the blade 24 at a different distance from the rotation axis 25 travels at a different tangential speed for a particular rotation rate of the rotor 12, which tangential speed is proportional to the angle of attack. The result is a blade 24 which is twisted in cross-sectional shape so that the rotational force exerted on the blade by the wind directed along arrow W, which effects rotation of the rotor 12 with the blade being displaced in direction of arrow M, is uniform along the blade length. The obtuse angle of the airfoil chord changes continuously and smoothly through the length of the blade 24 from the inner end 27 to the outer end 28. The leading edges 32 lie in a respective common radial plane 41 and the trailing edges 33 lie in a respective common radial plane 42, both radial planes 41 and 42 being parallel to one another.

It has been found that for optimal performance the obtuse angle θ1 at the inner end 27 lies in the range 92 to 100 degrees and preferably in the range 95 to 99 degrees, and that indicated at θ2 at the outer blade end 28 lies in the range 110 to 140 degrees and preferably in the range 120 to 135 degrees. In other words, the obtuse angle θ1 at the inner blade end 27 is no less than 92 degrees and the obtuse angle θ2 at the outer blade end 28 is no greater than 140 degrees with all intermediary radial blade locations having respective obtuse angles falling within this range. An average of the obtuse angles lies at least in the broad range 100 to 125 degrees, preferably in the narrower range 106 to 117 degrees and most preferably is in the order of 112 degrees.

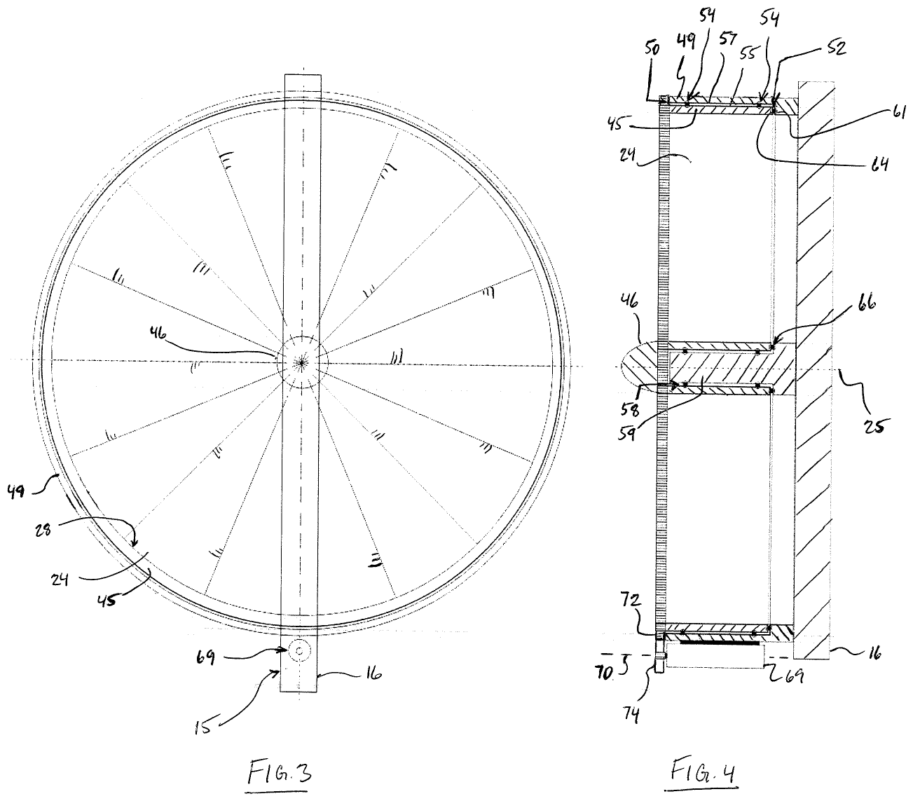

Referring to FIGS. 3 and 4, the rotor 12 comprises an outer or peripheral ring 45 connected or attached to the blades 24 at the outer ends 28 of the blades 24 opposite to a hub 46 of the rotor to which the inner ends 27 of the blades 24 are connected or attached. The rotor ring 45 is cylindrical around the rotor axis 25 such that the full width of the blades 24 from leading to trailing edges 32, 33 are connected to the rotor ring 45. Further, the rotor mount 15 includes a stator ring 49 at the rotor ring 45 and defining rotational bearings 50 allowing the rotation of the rotor ring 45 and a thrust bearing 52 holding the rotor 12 against axial movement. The rotational bearings 50 comprise a plurality of angularly spaced roller bearings 54 mounted between an outwardly facing surface 55 of the rotor ring 45 and an inwardly facing surface 57 of the stator ring 47. In the illustrated arrangement there are provided two axially spaced apart outer races of the rotational bearings 50 between the rotor ring 45 and the stator ring 49, and a corresponding pair of axially spaced inner races of rotational bearings 58 between the hub 46 and a rotor shaft 59 defining the rotor axis 25. To help confine and resist axial movement of the rotor 12, the stator ring 49 includes a forwardly facing stator surface 61 lying generally in a radial plane of the stator ring 49, which is perpendicularly transversely oriented to the rotor axis 25, against which the rotor ring 45 applies axial force from the prevailing wind. The thrust bearing 52 are mounted between this forwardly facing stator surface 61 and a rearwardly facing surface 64 of the rotor ring 45. A second thrust bearing 66 is mounted generally at the rotor shaft 59 to provide additional support against axial movement of the rotor 12.

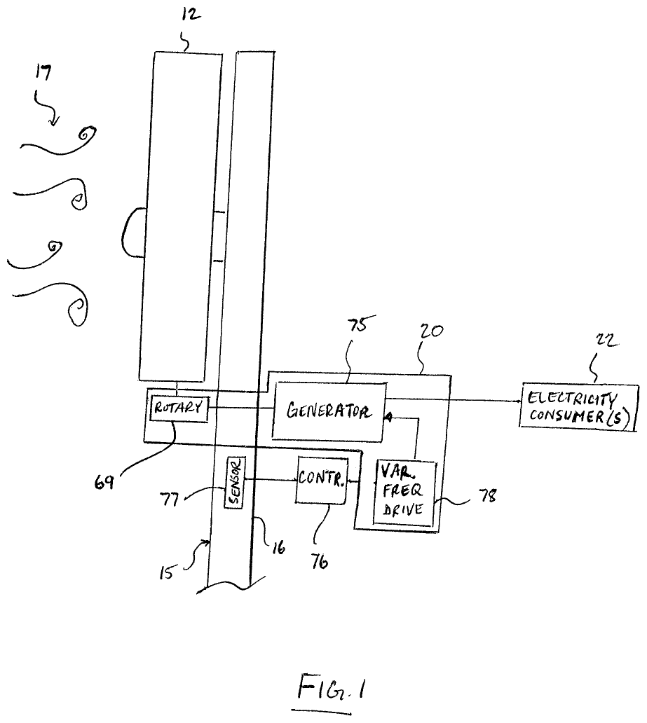

To cooperate with the rotor ring 45 to transfer the kinetic energy of the rotation of the rotor 12 to the generation system 20, the generation system 20 includes a rotary member 69 mounted on the stator ring 49 at a fixed angular position thereon for rotation about an axis 70 parallel to the rotor axis 25. The rotor ring 45 carries an annular member 72 for engaging and driving the rotary member 54 at a rate greater than that of the rotor 12 as the rotor ring 45 rotates past the rotary member, such that the rotary member 69 rotates at a rate at least 25 times and preferably 100 times greater than that of the rotor 12. The annular member 72 comprises a peripheral ring such as a belt or chain having outward projections for driving a sprocket 74 on the rotary member 69. That is, the outward projections of the peripheral ring 72 mesh with the sprocket 74 so that rotation of the rotor ring 45 in turn causes rotation of the rotary member carrying the sprocket 74. Referring back to FIG. 1, the rotary member 69 is operatively connected to a generator 75 of the generation system 20 and thus drives the generator. In this manner, the relatively low rotation rate of the rotor 12 is converted to a much higher rotation rate at which a conventional generator 75 of the generation system 20 is better suited to operate, thereby providing more efficient electrical power generation.

For efficient operation, operating the wind turbine 10 comprises determining for each of a plurality of wind speeds a relationship between rotation rate and optimum power output, and varying the power output of the generation system 20 to change the load on the rotor 12 to maintain the rotation rate at or adjacent the rotation rate which provides the optimum power output. The relationship is obtained for the different wind speeds as stored data and, during operation, the wind speed is measured so as to determine the optimum rotation rate and the generation system 20 is varied to maintain the load at a required level to maintain the optimum rotation rate. For example, the data is stored on a controller 76 which is operatively connected to the generation system 20 and the current wind speed can be measured using a conventional system of sensors 77 operatively connected to the controller 76. The load is maintained at a required level to maintain the optimum rotation rate by detecting whether, for the prevailing wind speed, the rotor 12 is operating at optimum rotation rate and, if not, by varying the power output to change the load and thus the rotation rate. In other words, the generation system 20 can be operated as a regenerative brake to modify the mechanical rotation rate of its input so as to affect the rotation rate of the rotor which is operatively mechanically coupled to the generation system input. By modifying the effective electrical load as seen by the generation system at its output, for example using a variable frequency drive 78 of the generation system 20 to change the power output, the effective mechanical load at the generation system's input which is seen by the rotor 12 can be modified to return the rotor to its optimum rotation rate.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of operating a wind turbine comprising:
a rotor;
a rotor mount for supporting the rotor in a prevailing wind such that the flowing of the wind at a wind speed causes rotation of the rotor at a rotation rate which varies in response to wind speed;
a generation system responsive to the rotation of the rotor to generate an electrical power output which applies a load to the rotor;
the method comprising:
determining for each of a plurality of wind speeds a relationship between rotation rate and optimum power output and varying the power output of the generation system to change the load on the rotor to maintain the rotation rate at or adjacent the rotation rate which provides the optimum power output.

2. The method according to claim 1 wherein the relationship is obtained for the different wind speeds as stored data and wherein, during operation, the wind speed is measured so as to determine the optimum rotation rate and the generation system is varied to maintain the load at a required level to maintain the optimum rotation rate.

3. The method according to claim 1 wherein the load is maintained at a required level to maintain the optimum rotation rate by detecting whether, for the prevailing wind speed, the rotor is operating at optimum rotation rate and if not by varying the power output to change the load and thus the rotation rate.

4. The method according to claim 1 wherein the generation system includes a variable frequency drive to change the power output.

5. The method according to claim 1 wherein the rotor comprises:
a plurality of blades mounted at angularly spaced locations for rotation about an axis, each blade extending generally radially outwardly from the axis and including an inner blade end and an outer blade end;
each blade having at each location along its length a shape in cross-section which defines an airfoil;
the airfoil having at each said location a leading edge facing the prevailing wind, a trailing edge, a lift surface and an opposed surface where a distance along the lift surface from the leading edge to the trailing edge is greater than a distance along the opposed surface from the leading edge to the trailing edge from the leading edge to the trailing edge;
the airfoil having at each said location a straight line joining the leading edge and the trailing edge lying at an obtuse angle to a radial plane;
wherein the obtuse angle increases from the inner end of the blade to the outer end;
and wherein at each said location the obtuse angle is proportional to a length of a radius from the axis to the line.

6. The method according to claim 5 wherein an average of the obtuse angles lies in the range 100 to 125 degrees, preferably in the range 106 to 117 degrees and most preferably in the order of 112 degrees.

7. The method according to claim 5 wherein the obtuse angle at the inner end lies in the range 92 to 100 degrees and preferably in the range 95 to 99 degrees.

8. The method according to claim 5 wherein the obtuse angle at the outer end lies in the range 110 to 140 degrees and preferably in the range 120 to 135 degrees.

9. The method according to claim 5 wherein the obtuse angle at the inner end is no less than 92 degrees and the obtuse angle at the outer end is no greater than 140 degrees.

10. The method according to claim 5 wherein the obtuse angle changes continuously and smoothly through the length of the blade from the inner end to the outer end.

11. The method according to claim 5 wherein the leading edges lie in a common radial plane and the trailing edges lie in a common radial plane.

12. The method according to claim 5 wherein the inner end is located at a hub to which the blades are attached.

13. The method according to claim 5 wherein the outer end is located at an outer ring to which the blades are attached.

14. The method according to claim 13 wherein the ring is cylindrical around the axis.

15. The method according to claim 1 wherein the rotor comprises a plurality of blades mounted at angularly spaced locations for rotation about an axis, each blade extending generally radially outwardly from the axis and including an inner blade end and an outer blade end;
the rotor comprising a peripheral rotor ring connected to the blades at the outer end of the blades;
the rotor mount including a stator ring at the rotor ring and defining rotational bearings allowing the rotation of the rotor ring and a thrust bearing holding the rotor against axial movement;
the generation system including a rotary member mounted on the stator ring at a fixed angular position thereon for rotation about an axis parallel to the rotor axis;
the rotor ring carrying an annular member for engaging and driving the rotary member at a rate greater than that of the rotor as the rotor ring rotates past the rotary member.

16. The method according to claim 15 wherein the rotational bearings comprise a plurality of angularly spaced roller bearings mounted between an outwardly facing surface of the rotor ring and an inwardly facing surface of the stator ring.

17. The method according to claim 15 wherein the stator ring includes a forwardly facing stator surface lying generally in a radial plane of the stator ring against which the rotor ring applies axial force from the prevailing wind.

18. The method according to claim 15 wherein the annular member comprises a peripheral ring such as a belt or chain having outward projections for driving a sprocket on the rotary member.

19. The method according to claim 15 wherein the rotary member rotates at a rate at least 25 times and preferably 100 times greater than that of the rotor.

20. A wind turbine comprising:
a rotor;
a rotor mount for supporting the rotor in a prevailing wind such that the flowing of the wind at a wind speed causes rotation of the rotor at a rotation rate which varies in response to wind speed;
a generation system responsive to the rotation of the rotor to generate an electrical power output which applies a load to the rotor;
the rotor comprising:
a plurality of blades mounted at angularly spaced locations for rotation about an axis, each blade extending generally radially outwardly from the axis and including an inner blade end and an outer blade end;
each blade having at each location along its length a shape in cross-section which defines an airfoil;
the airfoil having at each said location a leading edge facing the prevailing wind, a trailing edge, a lift surface and an opposed surface where a distance along the lift surface from the leading edge to the trailing edge is greater than a distance along the opposed surface from the leading edge to the trailing edge;
the airfoil having at each said location a straight line joining the leading edge and the trailing edge lying at an obtuse angle to a radial plane;
wherein the obtuse angle increases from the inner end of the blade to the outer end;
and wherein at each said location the obtuse angle is proportional to a length of a radius from the axis to the line.

21-29. (canceled)

30. A wind turbine comprising:
a rotor;
a rotor mount for supporting the rotor in a prevailing wind such that the flowing of the wind at a wind speed causes rotation of the rotor about a rotor axis at a rotation rate which varies in response to wind speed;
a generation system responsive to the rotation of the rotor to generate an electrical power output which applies a load to the rotor;
the rotor comprising a plurality of blades mounted at angularly spaced locations for rotation about an axis, each blade extending generally radially outwardly from the axis and including an inner blade end and an outer blade end;
the rotor comprising a peripheral rotor ring connected to the blades at the outer ends of the blades;
the rotor mount including a stator ring at the rotor ring and defining rotational bearings allowing the rotation of the rotor ring and a thrust bearing holding the rotor against axial movement;
the generation system including a rotary member mounted on the stator ring at a fixed angular position thereon for rotation about an axis parallel to the rotor axis;
the rotor ring carrying an annular member for engaging and driving the rotary member at a rate greater than that of the rotor as the rotor ring rotates past the rotary member.

31-34. (canceled)
